(19) United States
(12) Patent Application Publication
(10) Pub. No.: US 2011/0010244 A1
(43) Pub. Date: Jan. 13, 2011

(54) SPONSORED APPLICATION LAUNCHER SUGGESTIONS

(75) Inventors: Kyle Davis Hatridge, Seattle, WA (US); Patrick Brian Wilburn, Redmond, WA (US); Aidan Stanley Marcuss, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/501,212

(22) Filed: Jul. 10, 2009

(51) Int. Cl. G06F 9/445; G06Q 30/00

(52) U.S. Cl. 705/14.53; 717/176; 705/14.55

(57) ABSTRACT

A content delivery system that is based on user interest. The system includes client and server components. At each client, information about user interactions is collected and compared to information defining a set of user interest categories. In this way, the client can determine one or more interest categories in which the user fits. The client can then offer to the user content that is classified in accordance with the same set of user categories. The server can supply the client with the information defining user interest categories and a manifest of content options with associated categories. Additionally, the server can receive indications of when each content offering is presented to a user and when the user selects to acquire a content option. The server may also participate in offering the content. The content may be software applications.

### BACKGROUND

Personal computers are frequently delivered to users loaded with offers to acquire software applications. These advertisements are frequently placed on the computer desktop by the computer manufacturer, sometimes as links to websites. Through these websites, users may obtain program code for an advertised application or, if the program code is already installed on the computer, unlock the program code so that the application can be used. If a user wishes to use such an application program, the user can select the link and, through the website, engage in a transaction with the software vendor providing the program to obtain a license to use the software and access to the program code.

Some users choose to obtain applications programs in this fashion, finding it a simple approach to identify applications suitable for use with their computers. Though, other users find this approach to offering application programs confusing or disruptive.

Nonetheless, there is a financial incentive for the computer manufacturer to place these advertisements. In many instances, the computer manufacturer is paid by software vendors to place advertisements for software applications.

### SUMMARY

The experience for a user of a computer may be improved by collecting data indicating user interactions with the computer to determine one or more categories of user interest. Content, classified as of interest to users in a category matching a category assigned to the user, may then be offered to the user.

One or more categories may be assigned to a user by collecting data indicating interactions between the user and the computer. Such interactions may include, for example, visiting web sites from the computer, submitting search queries to search engines, having a software application open for a period of time or editing documents stored on a disk of the computer. Information about user interactions with the computer gained through collecting user interactions data may be compared to classification criteria. The classification criteria may be obtained by the computer and applied locally, avoiding the need to communicate information about user interactions outside the local computer environment.

The content offered to the user may include software applications. The user may be notified of the availability of the software applications deemed appropriate for users in a user-interest category to which the user of a computer has been assigned. Such notification may be made at a time determined based on user action. In some embodiments, the user may be alerted to the availability of software applications matching categories of interest to the user when the user activates a program launcher that displays available software applications. At that time, software applications may be displayed in a display area separate, but closely linked to, a display area used to display to the user software programs loaded and available for use on the computer. By selecting a software application available from the display area holding offered software applications, interactions are initiated between the user computer and a server from which the offered software application may be obtained. As a result of these interactions, an available software application may be unlocked or otherwise made available to the user.

A server, or other computer system, that supports category-based content offers may maintain information about software applications and categorization information. This information may be obtained by user computers or other client devices. When a client device offers content to the user, the client device may indicate that content was presented to the user. The server may track and aggregate such indications for reporting to vendors of the software applications or other purposes.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a high-level architectural diagram of an environment in which the invention may be practiced;

FIG. 2 is an architecture diagram of components for user interactions data collection and categorization in a client computing device;

FIG. 3A is an exemplary networking stack such as may be implemented on a client computing device;

FIG. 3B is an exemplary networking command that may pass through a networking stack;

FIG. 4A is a flowchart illustrating a method of obtaining user permission for performing certain types of user interaction data collection;

FIG. 4B is a flowchart illustrating a method of obtaining user permission for sharing certain types of data;

FIG. 5 is a high-level flowchart illustrating a method of providing suggested content to a user of a client computing device;

FIG. 6A is a flowchart providing exemplary details for super-block 504 of FIG. 5, according to an embodiment in which the suggested content is a software application;

FIG. 6B is a flowchart providing exemplary details for super-block 504 of FIG. 5, according to an embodiment in which the suggested content is a user interface theme;

FIG. 7A is a flowchart providing exemplary details for super-block 508 of FIG. 5, according to an embodiment in which the suggested content is a software application;

FIG. 7B is a flowchart providing exemplary details for super-block 508 of FIG. 5, according to an embodiment in which the suggested content is a user interface theme;

FIG. 8A is a flowchart providing exemplary details for super-block 510 of FIG. 5, according to an embodiment in which the suggested content is a software application;

FIG. 8B is a flowchart providing exemplary details for super-block 510 of FIG. 5, according to an embodiment in which the suggested content is a user interface theme;

FIG. 9A is a user interface for an application launcher displaying newly available suggested software applications;

FIG. 9B is a dialog window notifying a user that new user interface themes are available for acquisition;

FIG. 10 is a user interface 1000 for selecting a new user interface theme for configuration on a client computer;

FIG. 11 is an exemplary desktop configuration showing a default theme;

FIG. 12 is an exemplary client desktop configured with a sports-related theme;

FIG. 13 is a user interface for reverting the configuration of a client computer to use a default theme;

FIG. 14A is web browser interface illustrating the delivery of targeted website content when a selected category is shared; and

FIG. 14B is a web browser interface illustrating the delivery of targeted website content with collected user interactions data are shared.

### DETAILED DESCRIPTION

The inventors have recognized and appreciated that conventional approaches to offering users of new computers content, such as software applications, are generally perceived by users as irritating and unhelpful. The visual clutter caused by numerous shortcuts to software applications and other content that are commonplace on the desktop of new personal computers may be a source of irritation. Users are forced to spend time evaluating each shortcut to determine whether it is needed and delete the unwanted ones.

Offering content in this fashion can also waste computer resources, creating another grounds of irritation for the user. In some instances, the shortcuts link to web servers that can supply software applications advertised through desktop shortcuts. In this case, each desktop shortcut takes up a relatively small amount of computer resources. Though, in other instances, the offered software applications may already be installed on the computer—though sometimes locked using digital rights management techniques to prevent the user from accessing them until a payment is made by the user. Selecting a shortcut may simply access information that unlocks a selected software application. But, even when the software applications are not unlocked, they consume resources.

Moreover, the vast majority of such software applications offered are not of interest to any particular user. Yet, such shortcuts may appear on the desktops of every computer shipped by a computer manufacturer. Consequently, most of the shortcuts on each computer are likely not to be used at all—creating the impression for the user that the desktop shortcuts are unhelpful.

However, by limiting the applications offered to users by offering content determined to be of likely interest to a user, the user is presented with less information and is less likely to be irritated by the offers. Moreover, because there is an increased likelihood that a user will want to acquire software applications that are of interest to the user, the user should perceive the offer of applications as more helpful.

According to some embodiments of the content delivery system described herein, customized content may be offered while being sensitive to user privacy concerns. A user computer may be operated to collect data indicating user interactions with the computer and derive from them one or more categories of user interest. The categories may be derived by applying classification criteria that can come from an external source. Further, in some embodiments, the user computer will request a manifest of available content with its associated classification. By comparing the user classification with the classification of available content, appropriate content can be selected to offer to the user. This selection can be made on the user computer.

User computers may report user selection to a server or other computer system that can supply the selected content, either by providing the code for the software application or by providing information that can unlock or otherwise enable the software application that is already stored on the user computer. The server can thus track provision of software applications to users, such as to collect a licensing fees from users or to track royalties owed to content providers. Information about activation of various software programs offered to users may be received at the server from multiple user computers, acting as clients to the server. This information may be aggregated to determine payment due to the software vendors.

Alternatively or additionally, the supplier of content, such as a vendor of software applications, may pay a fee to an operator of the system that offers software applications based on user interest. In this case, the server, or other computer, system may receive indications from the client computers as the client computers offer software applications to users. The server may aggregate these indications to determine a number of user “impressions” for each software application, which may be a basis for a fee from the supplier of the software application.

Fees collected for offering software based on user interest may be shared with parties who participate in the user interest-based content delivery system. For example, a computer manufacturer may load components of the system on a new computer before initial shipment to a customer. Those components may implement the client-side portions of the system, such as collecting data indicating user interactions with the computer, determining appropriate content choices, presenting the choices to the user, reporting impressions to a server or obtaining a usable version of an application when indicated by a user. To support payment of revenue with parties who enable the system, an identification of the party or parties who configured each client computer to participate in the system may be included in indications sent to the server. Consequently, the aggregated information on the server indicating number of user impression or number of software applications licensed to users may reflect the parties with whom fees for those actions are to be shared.

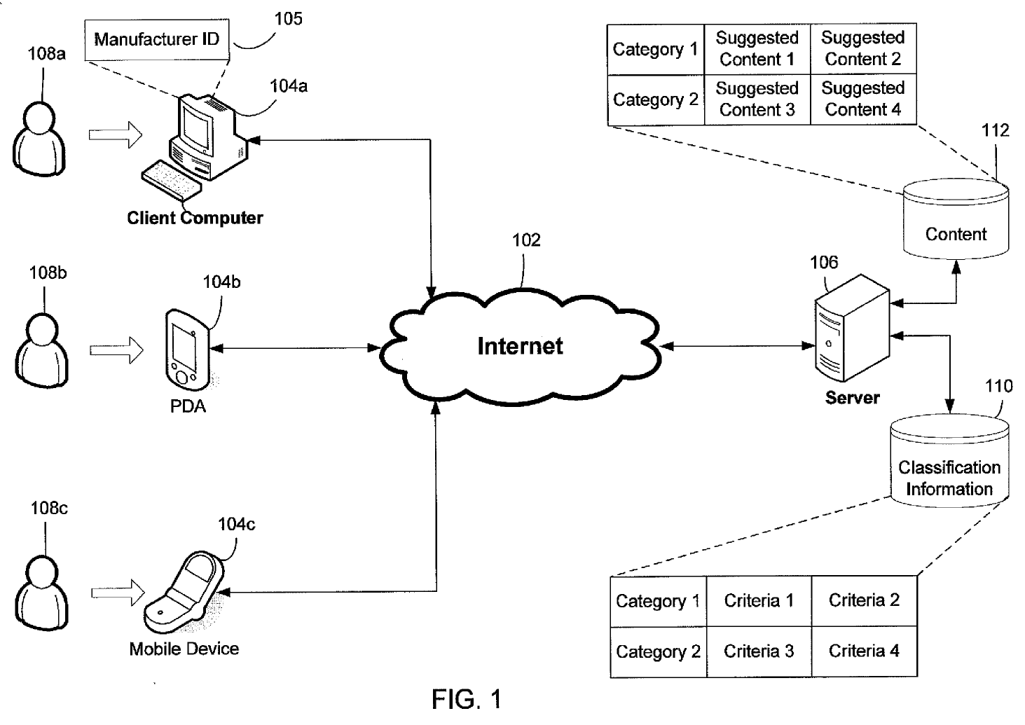

FIG. 1 is a high-level architecture diagram illustrating a networked computing environment in which some embodiments of a user-interest based content delivery system may be practiced. FIG. 1 includes computer network(s), which may be any suitable single or interconnected communications network(s), such as Internet 102. FIG. 1 also includes client computing devices 104 connected to Internet 102 over any suitable computer communications medium, including wired and wireless media. Client computing devices 104 may be any suitable type of networked computing device, such as a smart phone, laptop computer, desktop computer 104a, personal data assistant (PDA) 104b, or mobile device 104c, and may be implemented in any suitable combination of hardware and software. For example, the client computing devices 104 may be loaded with software, written in any suitable language, including an operating system, such as variants of the WINDOWS® operating system developed by Microsoft Corporation. Some computing devices, such as client computing device 104a, may include an identifier of the manufacturer of the client computing device, such as manufacturer ID 105. The identifier may be stored in suitable computer memory on the client computing device or may be accessible by querying a hardware component on the computing device.

In the environment of FIG. 1, Internet 102 is also connected to server computer 106 over any suitable communications medium. Server computer 106 may be any suitable combination of hardware and software, and may be loaded with an operating system, such as variants of the WINDOWS® Server operating system developed by Microsoft Corporation. While server computer 106 is illustrated in FIG. 1 as a single computing device, it may be implemented as a plurality of computing devices that may be configured to operate as a coherent system in any suitable way, such as for load-balancing or redundancy purposes. Additionally or alternatively, the functionality discussed below ascribed to server 106 may be divided along functional boundaries among a plurality of computing devices. Server computer 106 may be part of or may be coupled to an advertising platform or may be another content provider such as a provider of software. Server computer 106 may be operated by a software manufacturer, or by any other suitable entity.

User 108a, 108b, and 108c may interact with client computing devices 104a, 104b, and 104c, respectively. Although each client computing device is illustrated in FIG. 1 as associated with a single user, there need not be a one-to-one relationship between users and client computing devices, as, for example, a user may use multiple client computing devices or multiple users may interact with one computing device. Users of a computing device may be identified by the computing device in any suitable way. For example, a user may be identified by logging in. Additionally or alternatively, a user may be recognized by a client computing device based on behavior patterns of the user. User interactions with client computing devices may include, for example, interacting with a software or hardware component on one of client computing devices 104a . . . 104c, accessing or manipulating data stored in volatile or non-volatile memory on one of client computing devices 104a . . . 104c, or connecting to other computing devices over one or more computer networks, such as Internet 102. Each of client computing devices 104a . . . 104c may monitor such user interactions with the client computing device.

The client computing devices 104a . . . 104c may categorize their respective users 108a . . . 108c into one or more of a plurality of categories. Selecting a category may be based on criteria or indicia of user interactions for each category indicating user association with the category. Classification information, including a list of categories and indicia or criteria of user interactions, may be obtained by each of client computing devices 104 in any suitable way. For example, the classification information may be stored locally on each of client computing devices, or additionally or alternatively may be obtained from another computing device, such as by downloading it from server computer 106. Once a user is assigned to a category, category specific content may be suggested to the user or other category based actions may be taken.

In the example of FIG. 1, server computer 106 contains or otherwise is connected to a data store 110 storing user classification information. Server computer 106 may also maintain content information, illustrated in FIG. 1 as being stored in data store 112, in which each category is associated with one or more instances of suggested content. The client computing devices 104a . . . 104c, may interact in some way with the server computing device 106 to select content based on a category and to suggest the content to a user of a client computing device.

Data store 110 and data store 112 may be any suitable computer storage, such as a database or file system implemented on any suitable computer storage medium. While data store 110 and data store 112 are illustrated as two separate data stores, alternatively, the data stored in each of data store 110 and data store 112 may be combined into a single data store, or generally organized and distributed among a greater or lesser number of data stores in any suitable way.

Suggested content may be obtained or displayed on client computing devices 104a . . . 104c, based on a match between the selected category and the suggested content associated with the category. In some embodiments, a list of suggested content may be obtained by client computing devices 104a . . . 104c from the server computer 106 and the match is performed locally on the clients based on filtering the content in accordance with the selected category, while in other embodiments a selected category may be transmitted from client computing devices 104a . . . 104c to allow the server computing device 106 to perform the match. The suggested content may include, for example, user interface themes, available applications, available plugins or extensions to already installed applications, website content, or advertisements, including those displayed on a website.

Information such as metrics indicating the use of the suggested content by the user of a client computing device may be sent to the server 106. The information may be used for various purposes, such as for determining a level of user interest in the suggested content or for billing purposes. Such information may include an identifier of the manufacturer of the client computing device, such as the manufacturer ID 105, which may be used, for example, in embodiments in which the manufacturer receives payment from a provider of the suggested content for the use of the suggested content by the user of the client computing device.

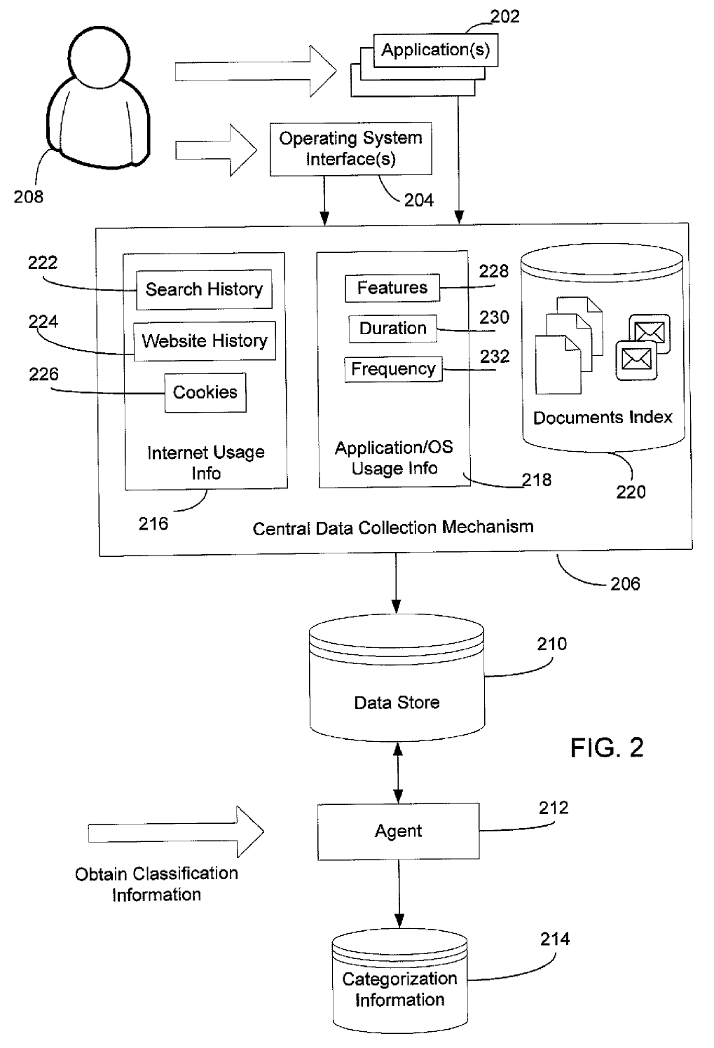

More details of the monitoring and categorization for user interactions performed by client computing devices 104 are illustrated in FIG. 2. FIG. 2 is an architecture diagram of components in a client computing device of user interactions monitoring and categorization. FIG. 2 illustrates a user 208, which could be one of users 108a . . . 108c, interacting with software modules loaded on a client computing device, such as one or more application(s) 202 or operating system interface(s) 204. For example, the application(s) 202 could include a web browser, word processor application, spreadsheet application, or email client. FIG. 2 also includes a data collection mechanism 206, an agent 212, data store 210, and data store 214.

Data collection mechanism 206 and agent 212 may be implemented in any suitable way, including as software components comprising machine executable instructions. For example, they may be components of an operating system loaded on a client computing device. Data collection mechanism 206 and agent 212 may, for example, be implemented as a software service or daemon that periodically performs its functionality in the background. Data collection mechanism 206 may collect user interactions data in real time or periodically, including by monitoring or measuring user interactions with the client device. While the data collection mechanism 206 and agent 212 are illustrated as two components, the functionality ascribed to them may be divided or combined in any suitable number of components. Similarly, data store 210 and data store 212 may be implemented in any suitable way, including with a database or file system over any suitable computer storage medium, and may be divided or combined into any suitable number of data stores.

Data collection mechanism 206 collects user interactions with application(s) 202 and operating system interface(s) 204, and stores collected user interactions data in data store 210. Data collection mechanism 206 may collect the user interactions in a number of ways, including collecting internet usage information 216, application or operating system usage information 218, or a collecting information stored on the client (e.g., by scanning documents index 220).

Internet usage information 216 may be obtained, for example, by analyzing data maintained by a particular internet application loaded on the client computing device. For example, data collection mechanism 206 may analyze a search history 222, websites visited stored in a web browser history 224, or web browser cookies 226 maintained and stored locally by a web browser.

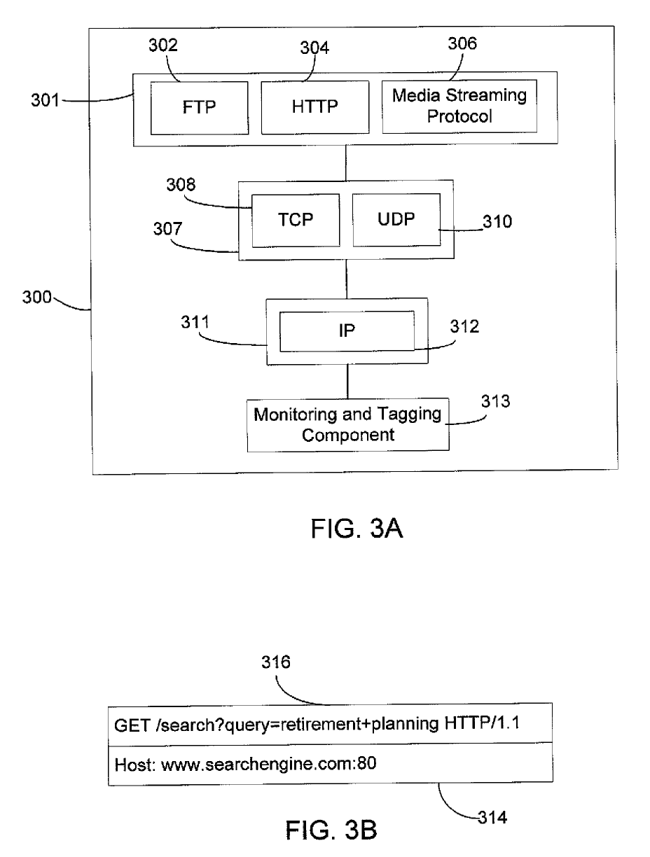

Additionally or alternatively, data collection mechanism may obtain internet usage information 216 by monitoring networking commands passing through a networking stack on the client computer device. FIG. 3A illustrates an exemplary networking stack 300, including a number of protocol processing modules at various layers of the stack. For example, at higher layer, networking stack 300 includes upper level processing modules 301, such as FTP (File Transfer Protocol) processing module 302, HTTP (Hypertext Transmission Protocol) processing module 304, and Media streaming protocol processing module 306. At a middle layer, networking stack 300 includes middle level processing modules 307, such as TCP (Transmission Control Protocol) processing module 308 and UDP (User Datagram Protocol) processing module 310. At a lower layer, networking stack 300 includes lower level processing modules 311, such as IP (Internet Protocol) processing module 312.

The networking stack 300 may also include a monitoring and tagging component 313. Monitoring and tagging component 313 may monitor networking commands passing through the stack. In this way, monitoring and tagging component 313 may collect information about interactions with any web site from any browser or any web-enabled application. Though, information passing through the networking stack that is to be collected may be identified in any suitable way. For example, it may be identified based on a port identified in packets passing through the stack. Alternatively, it may be identified by destination address in packets or by source address, such that packets originating from one or more web browsers or web-enabled applications can be identified and collected.

Monitoring and tagging component 313 may also insert an identifier into outgoing messages directed to a content provider. In some embodiments, the identifier may uniquely identify the user to the content provider without including any sensitive or private user information. The identifier may be generated based on characteristics of a client computing device operated by the user, such as an IP address or MAC address, or it may be generated by the content provider, and stored on the client computing device. For example, the identifier may be inserted by the monitoring and tagging component 313 into all website requests directed to websites operated by the same content provider. The identifier may serve as a link between a website request made by the user and data already provided by the user to the content provider, so that content delivered in response to the website requests may then be targeted to the user.

FIG. 3B illustrates an exemplary networking command that may pass through networking stack 300. FIG. 3B includes a request, sent in this example according to version 1.1 of the HTTP protocol, to connect to a website. This type of request may typically be generated by an internet application, such as a web browser executing on the client computing device. The request includes a website identification 314, which in this example, is www.searchengine.com. Website identification 314 may identify an entire website, a portion of a website, or a portion of a particular webpage. For example, the website identification 314 may identify pages in a sports-related section of a website. The request may also include data, such as text, transmitted to the website, such as may have been received as input in an HTML form, for example. Text, such as words, transmitted to the website may correspond to a search query transmitted to the website. For example, the exemplary request of FIG. 3B includes a search query 316, “retirement+planning.” Text of a search query, such as “retirement planning,” may be useful in selecting a category. For example, a particular category may be selected if text in a search query is in a list of portions of text, such as words, included in the classification criteria for the category.

Analyzing networking commands passing through networking stack 300 has an advantage in that it is independent of any application that generated the command, and thus does not require data collection mechanism 206 to have knowledge of any particular information maintenance mechanism used by a particular internet application. Collecting Internet usage information by analyzing networking commands passing through a networking stack has another advantage in that it allows aggregation of commands sent across multiple applications that may be used to access the Internet.

Collecting user interactions data such as Internet usage locally on a client computer also has advantages compared to the characterization of user behavior typically performed by internet websites. Individual websites frequently track pages visited by a user on the website, and may use this history to present to the user more relevant content on that website. However, the information available to an individual website is limited to the pages visited and behavior of the user on that website, and thus is fragmented across a large number of websites. Therefore, aggregating the Internet usage of a user not only across multiple websites but also across multiple applications, by analyzing networking commands passing through a networking stack, as discussed above, allows for a more complete view to be assembled of the user interest.

Returning to FIG. 2, data collection mechanism 206 may also collect application or operating system usage information 218. This information may include, for example, features 228 of an application or an operating system used by user 208, a duration 230 that an application, application feature, or operating system feature is used by user 208, or a frequency 232 that an application, application feature, or operating system feature is used by the user 208. The application or operating system usage information 218 may be collected in any suitable way, including using an existing event logging mechanism, in which particular features or applications may be associated with particular events.

Data collection mechanism may also collect other information stored on the computer, such as in documents index 220. The stored information may include documents stored as files on the computer, such as, for example, word processing documents or spreadsheet documents. The stored information may also include additional information, such as emails. The document index 220 may be in any suitable format, including an existing documents index used by an indexing service on the client computing device.

Based on user interactions data stored in data store 210 and classification information, agent 212 may select a matching category. As was discussed in connection with FIG. 1, the classification information may be stored locally, or may be obtained from another source, such as server computer 106 in the environment of FIG. 1. After having selected a matching category, agent 212 may store the matching category in a data store 212 containing categorization information.

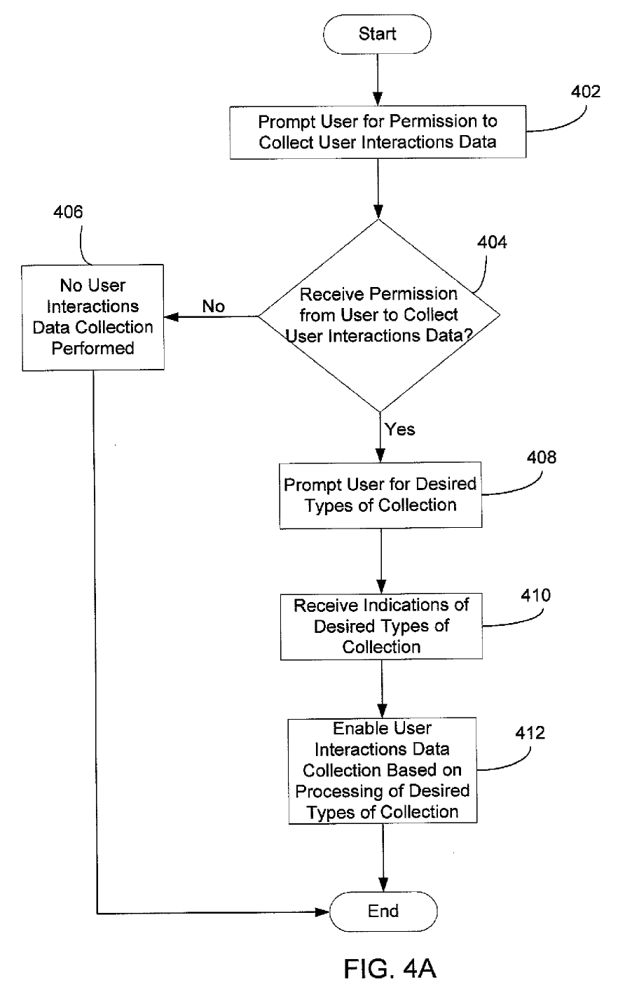

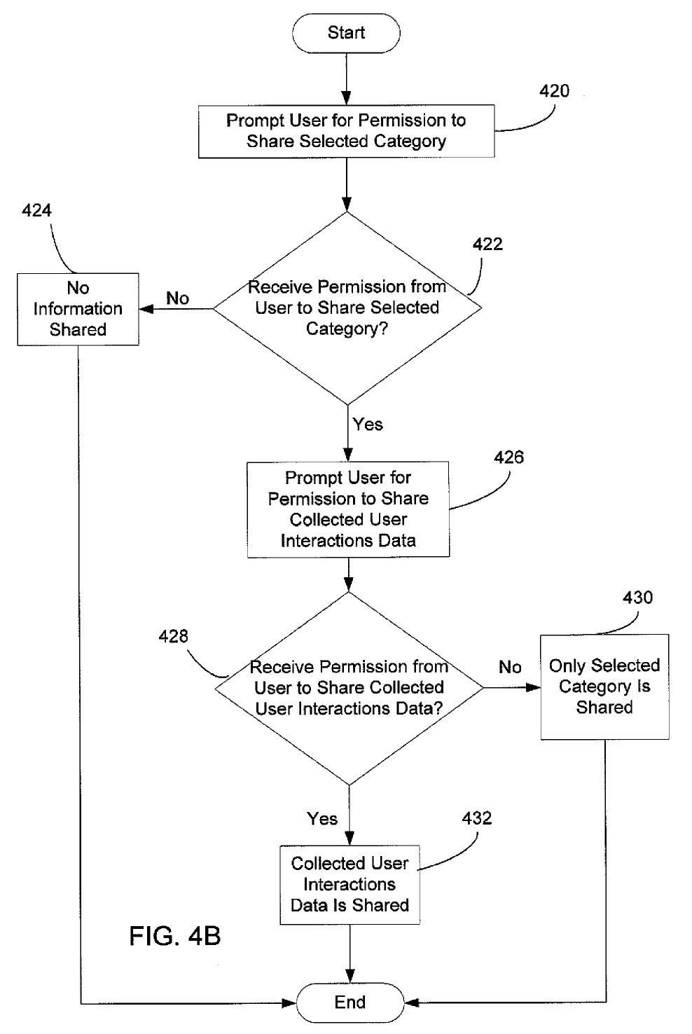

In some embodiments, before collecting user interactions data on a client computing device, such as one of client computing device 104a . . . 104c, user permission may first be obtained. For example, in some embodiments, no collection of user interactions data, such as by the monitoring of user interactions, may be performed by default, and collection may therefore not be performed unless explicitly allowed by a user. FIG. 4A is a flowchart of a method of obtaining user permission for performing certain types of user interaction data collection. The flowchart may be implemented in software, such as, for example, as part of the data collection mechanism 206. The software implementing the method may be launched automatically, for example, at a determined time, such as at first boot-up of a client computing device, or it may be explicitly invoked by the user, such as in a configuration settings module for an operating system loaded on the client computing device.

At block 402, the method may include prompting the user for permission to collect user interactions data. At block 404, a determination is made whether permission has been received from the user to collect user interactions data. If it is determined that the user has not given permission for user interactions data collection, the method may proceed to block 406, in which no user interactions data collection is performed. The determination that the user has not given permission may be made as a result of an explicit indication from the user, or additionally or alternatively, it may be a default position taken by the computing client device if the user has not given any indication whether user interactions data collection may be performed. The flowchart may be done at this point.

Alternatively, if it is determined at block 404 that the user has given permission to collect user interactions data, the user may then be prompted at block 408 to specify a desired type of collection. That is, in some embodiments, the user may be able to selectively allow certain types of user interactions data collection, while disallowing other types of collection. The types of user interactions data collection that may be allowed or disallowed by the user may include, for example, any of the types of collection performed by data collection mechanism 206, such as, collecting internet usage, such as website history, search history, cookies, either from an internet application, or by inspecting the networking stack, collecting application or operating system usage, including features, duration, and frequency, or collecting data in stored documents, such as files or emails.

At block 410, indications of the desired types of collection are received from the user, and at block 412, user interactions data collection is enabled based on the desired types of collection received from the user. The flowchart of FIG. 4A is then done at this point.

Besides obtaining user permission to collect user interactions data, permission may be obtained from the user to determine what type of data may be shared. If user permission has been granted, the data may be shared with server 106, for example, or with another third party, which may then provide suggested content to the user, based on the shared data. FIG. 4B is a flowchart of a method of obtaining user permission for sharing certain types of data with a third party. The flowchart may be implemented in software, such as, for example, as part of the agent 212 or the data collection mechanism 206. The software implementing the method may be launched automatically, for example, at a determined time, such as at first boot-up of a client computing device, or it may be explicitly invoked by the user, such as in a configuration settings module for an operating system loaded on the client computing device.

As discussed above, a client may select a category based on a match between classification information and collected user interactions data. At block 420, the method may include prompting the user for permission to share one or more such selected categories. At block 422, a determination is made whether permission has been received from the user to share a selected category. If it is determined that the user has not given permission for sharing a selected category, the method may proceed to block 424, in which no information related to user interactions will be shared. The determination that the user has not given permission may be made as a result of an explicit indication from the user, or additionally or alternatively, it may be a default position taken by the computing client device if the user has not given any indication whether a selected category may be shared. The flowchart of FIG. 4B may be done at this point.

Alternatively, if it is determined at block 422 that the user has given permission to share a selected category, the user may then be prompted at block 426 for permission to share the collected raw user interactions data, in order to receive more targeted content. At block 428, it is determined whether permission has been received from the user to share raw collected user interactions data. If it is determined that the user has not given permission for sharing user interactions data, the method may proceed to block 430, in which case only the selected category is shared, and the flowchart of FIG. 4B may be done at this point.

On the other hand, if it is determined that permission has been received from the user to share collected raw user interactions data, the method may proceed to block 432 in which case collected user interactions data is shared with the server 106, or other third party. In some embodiments, the default setting may be to not share more specific user interactions data unless the user has explicitly given permission to do so.

If the user has consented to sharing user interactions data, in some embodiments, the type of user interactions data shared with a third party may be limited to a particular type of data, such as, for example, Internet usage. Additionally or alternatively, in some embodiments, the user may select what type(s) of user interactions data may be shared (e.g., Internet usage, application/OS usage, etc.). Thus, some or all of the collected user interactions data may be shared. The flowchart of FIG. 4B is then done at this point.

Sharing the more specific user interactions data with a third party may enable more targeted content to be offered to the user than if only a more general user interest category is shared. Sharing more detailed information may result in advantages to the user and content provider alike. For example, user interactions may be sufficient to result in a match with a category of automobile shoppers. Thus, if a user shares a selected category with a content provider, the user may be presented with content, such as advertisements, related to a variety of vehicles made by multiple vehicle manufacturers. It may be, however, that the user interactions data includes multiple occurrences of a website searches related to a particular vehicle manufacturer, thus indicating a predisposition to purchase a vehicle made by the particular vehicle manufacturer. Thus, if the raw user interactions data is shared with the content provider, the user may receive advertisements informing the user of special targeted offers specific to the vehicle manufacturer of interest.

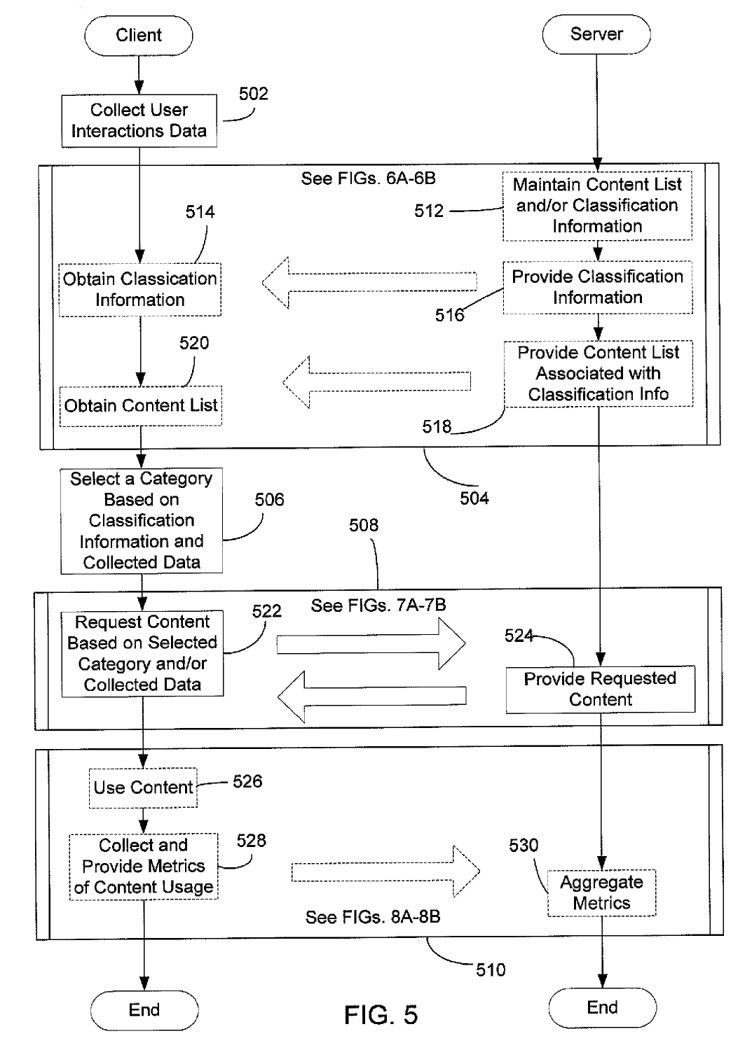

Once permission has been obtained from the user to collect user interactions data and to share data with a third party, such as the server 106, suggested content may be obtained based on the user interactions data. FIG. 5 is a high-level flowchart of a method of providing suggested content to a client computing device. The method may be implemented in any suitable way, including, for example by one of client computing devices 104 with the architecture according to the embodiment of FIG. 2, and by server computer 106. For example, some of the operations illustrated in FIG. 5 as being performed by the client may be performed by the data collection mechanism 206 and/or the agent 212.

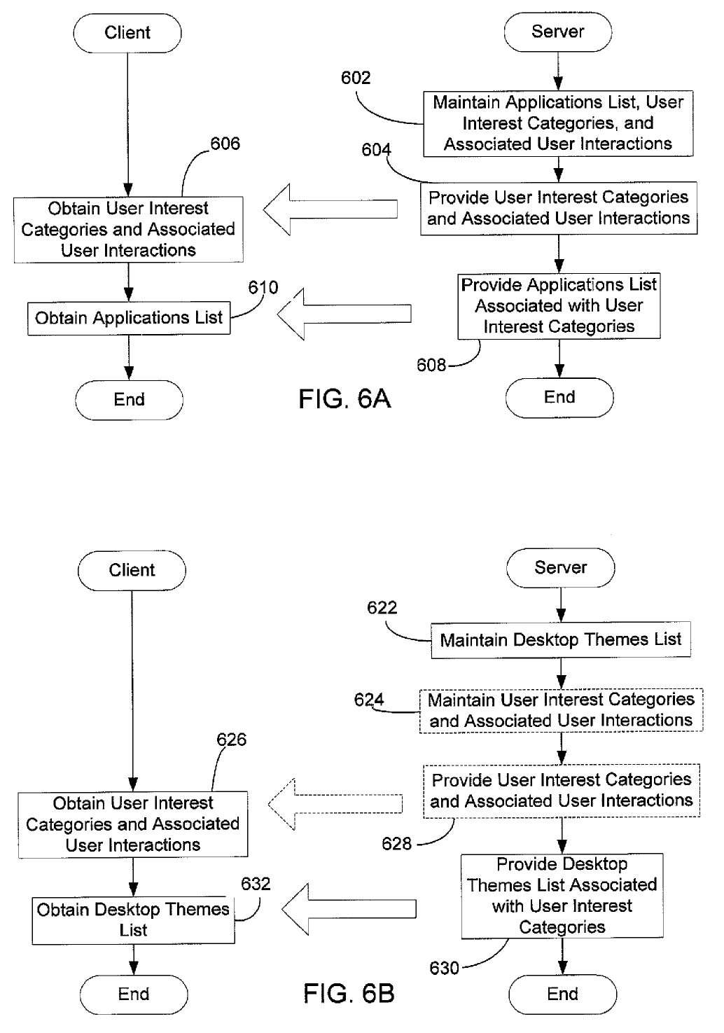

The flowchart of FIG. 5 includes super-blocks 504, 508 and 510, each of which is further exemplified by particular embodiments in FIGS. 6A-6B, 7A-7B, and 8A-8B, respectively. That is, FIGS. 6A, 7A and 8A provide further details of the steps in the superblocks for an embodiment in which the delivered content is suggested applications and FIGS. 6B, 7B and 8B provide further details of the steps in the superblocks for an embodiment in which the delivered content is user interface themes. Not all the blocks illustrated in the superblocks in FIG. 5 may pertain to the illustrated embodiments in FIGS. 6A-6B, 7A-7B, and 8A-8B. In particular, blocks or arrows illustrated with dashed lines may be considered optional in some embodiments. Though, it should be recognized that in other embodiments, subsets of the operations illustrated in FIG. 5 may be performed. Furthermore, in other embodiments, different or additional operations may be performed. In addition, some embodiments may provide other content besides suggested applications or user interface themes. For example, some embodiments may provide targeted website content, one type of targeted website content being an advertisement.

The process of FIG. 5 may begin once permission to collect user interactions data and to share data related to user interactions have been obtained from the user of the client computing device. At block 502, the client may collect user interactions data according to the user-desired settings, as discussed above. This step may be performed, for example, by the data collection mechanism 206.

At block 512, the server may maintain a content list and/or classification information. These may be in any suitable format, including the format illustrated by FIG. 1 as being stored in data store 110 and data store 112. That is, for example, the content list may associate each user interest category with one or more components of suggested content. The classification information may include a list of categories and indicia or criteria of user interactions indicating user membership in a category.

At block 514, the client may obtain classification information, which may be either stored locally or obtained from the server. In the latter case, the server, at block 516, may provide the classification information to the client. In such embodiments, the client may obtain classification information from the server in any suitable way, including by downloading the classification information or by periodically synchronizing a copy of classification information stored locally with classification information obtained from the server.

At block 518, the server may provide the client with the content list, in which, as discussed above, the content is associated with classification information, such as a user interest category. At block 520, the client may obtain the content list provided to it by the server.

At block 506, the client may select a category based on the classification information and the collected data. It may do this based on a match between the indicia or criteria indicating membership in a user interest category and the collected data. The match may be performed based on a precise match, such as a direct one to one matching, between the criteria indicating membership in a user interest category and the collected data, such as when every keyword in a list of keywords included in the criteria is included in the collected data. Additionally, or alternatively, probabilistic or statistical matching may be performed. For example, the matching could be based on Bayesian classifiers, based on a percentage of portions of text, such as words, in the collected data determined to be related to portions of text in a list associated with a user interest category, or could be based on a comparison of the number of portions of text in the collected data related to one user interest category versus another user interest category.

Additionally or alternatively, in some embodiments, the selection of a user interest category at block 506 may be based on interests explicitly indicated by the user. For example, in some embodiments, the user may specify his interests (e.g., sports or travel) in order to receive suggested content based on the interests he explicitly specified. In embodiments in which the user may explicitly indicate his interests, user interest categories based on the user-specified interests may be selected either instead of or in addition to user interest categories selected based on a match between the classification information and the collected data. The user may specify his interests in any suitable way. For example, a user may submit such user interest information over a website associated with the server. As another example, a user may provide user interest information to a configuration settings module for an operating system loaded on the client computing device, similar to that discussed above in connection with FIGS. 4A and 4B.

At block 524, the client may request content from the server based on the selected category and/or collected user interactions data. In some embodiments, the client may request particular content from a content list obtained from the server, in which the particular requested content is associated with the matching category. The content list may be obtained in any suitable way, such as, for example, by downloading or synchronizing content from the server. Alternatively or additionally, such as in embodiments in which the client may not have obtained a content list, the client may provide the selected category in the request to the server, in order to allow the server to deliver a choice of content matching the category.

In other embodiments, the data, such as the selected category or the user interactions data, may be provided to the server in advance along with a user identifier, and the client request for content may include the same user identifier. In some embodiments, the entity with which the client shares user interactions-related data may be different than the entity from which the client requests content. For example, the user interactions-related data may be shared with an advertising platform, while the request for content may be made with a content provider affiliated with the advertising platform. Thus, generally, the operations ascribed to the server may be divided on a functional level between various computing devices, including computing devices operated by different entities.

Providing a matching category to the user many include no personal or user identifying information, and therefore, respects a high degree of user privacy. In addition to, or instead of providing a selected category in the request to the user, the client may also provide the user interactions data itself, in order to allow the server to deliver even more targeted content. As discussed in the embodiment illustrated by FIG. 4B, user interactions data may be shared with a third party only if the user has explicitly given permission to do so.

In some embodiments, a user may request content of interest to the user by visiting a particular trusted location in which the user may be presented with choices of suggested content. For example, an operating system may include a feature that, in response to a user request for suggested content, directs the user via a URL (Uniform Resource Locator) to a pre-determined trusted location for locating and obtaining content of interest. While in some embodiments, visiting the trusted location may automatically present the user with content that matches the user's interest(s), such as if the request for content included a user identifier associated with user interactions-related data provided to the trusted location, as discussed above, the user may alternatively or additionally locate and obtain other content from the trusted location that may not have been previously matched to the user's interest(s). At block 524, the server may provide the requested content to the client.

In some embodiments, the client may use the content at block 526, and collect and provide to the server metrics of content usage at block 528. The metrics of content usage may include an identifier of the client manufacturer, such as manufacturer ID 105. At block 530, the server may aggregate the received metrics. This may include aggregating the metrics across a plurality of clients into a report. The information in the report based on the aggregated metrics may be used in a variety of ways, for example, for determining the level of user interest in the suggested content. As another example, the information in the report may be used for billing purposes, including receiving payment from an advertiser or supplying payment to a content provider or computer manufacturer, which may be identified by the identifier of the client manufacturer.

FIGS. 6A, 7A and 8A provide exemplary details for super-blocks 504, 508 and 510, respectively, for a particular embodiment in which the content is a suggested computer application that may be obtained and installed onto the client. It is to be appreciated that, while the content type discussed in connection with FIGS. 6A, 7A and 8A is suggested computer applications, other types of content, such as extensions or plugins to existing applications, may also be provided according to this embodiment. A suggested computer application may include an application including computer-executable instructions in one or more software modules that executes locally on a client computer, an application that executes remotely on one or more other computing devices, such as a web application, or any suitable combination of local and remote execution. A suggested computer application may also include a shortcut to a local or remote application, such as a web shortcut.

Following the collection of user interactions data performed at block 502, the flowchart turns to FIG. 6A, in which at block 602, the server may maintain an applications list, user interest categories, and associated indicia or criteria for user interactions that indicate membership in a particular user interest category. In some embodiments, each application may be associated with different indicia of user interactions, and each application may thus effectively be in its own category, while in other embodiments, a category may include multiple applications. In some embodiments the indicia of user interactions associated with an application may be provided to the server by a provider of the application, in which the provider is distinct from the entity that operates the server.

For example, the provider of a financial planning application may wish to offer an application to users who meet certain criteria, such as a user who has visited financial websites and has performed multiple web searches over the last month relating to retirement planning, who has used particular financial features of a spreadsheet application, or who has created documents stored on the client computing device containing appropriate keywords. The provider of the financial planning application may provide these criteria to the server for use as the associated indicia or criteria for user interactions that indicate that a user may be offered the financial planning application.

At block 604, the server may provide to the client the user interest categories and indicia of user interactions indicating membership in each user interest category, which the client may receive at block 606. At block 608, the server may provide the applications list, in which each application is associated with a user interest category. The client may obtain, at block 610, such as by downloading, the applications list from the server.

The flowchart of FIG. 6A is then done, and the flow proceeds back to block 506 of FIG. 5, in which, in the embodiment of FIGS. 6A, 7A and 8A, the client may select a category based on a match between the monitored user interactions data and the obtained indicia for user interactions that indicate membership in a particular user interest category. To continue the example of the financial planning application discussed above, if the monitored user interactions data matches the criteria provided by the financial planning application provider, the selected category may be the category associated with the financial planning application. In some embodiments, multiple categories may be selected when there may be multiple matches between monitored user interactions data and the obtained indicia for user interactions that indicate membership in a particular user interest category.

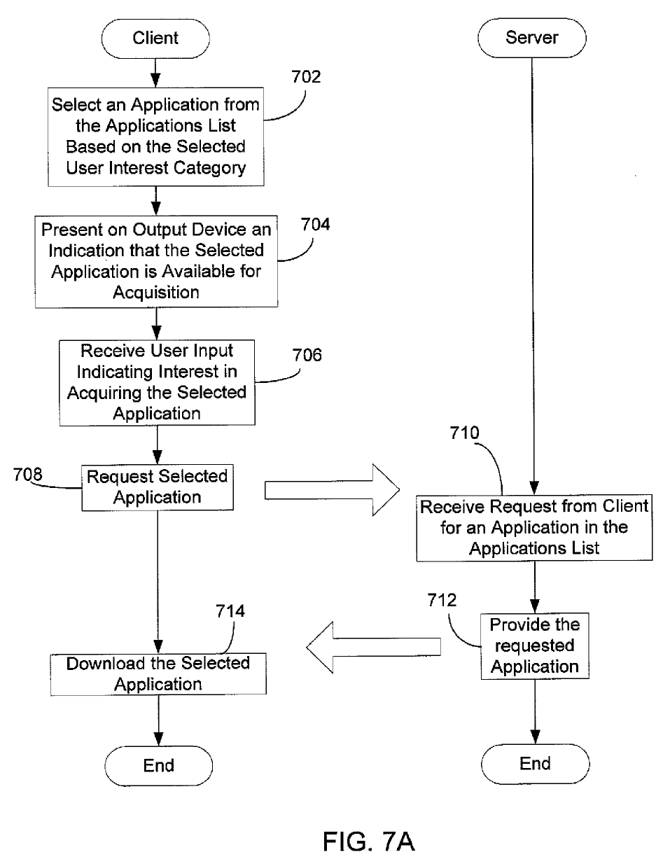

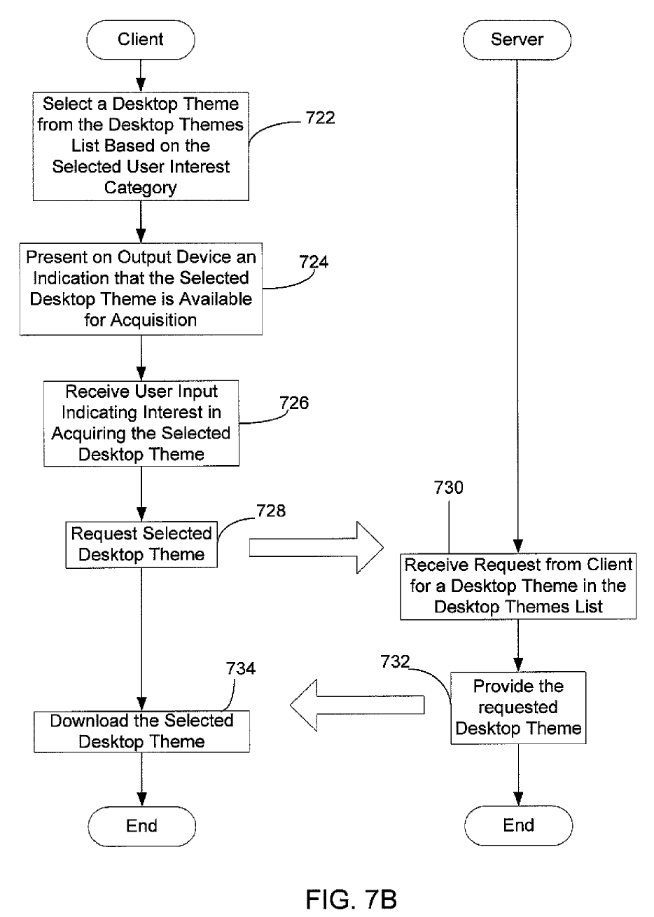

Turning to FIG. 7A, the client may, at block 702, select one or more applications from the applications list based on the selected user interest category. For example, the client may select application(s) whose associated user interest category match the category selected at block 506. At block 704, the client may present on an output device an indication that the selected application(s) are available for acquisition. The indication may be made in any suitable way, including as desktop icons, in a pop-up dialog window, or in a particular area of an operating system, such as in a particular area of an applications launcher, an icon tray, or an action center. At block 706, the client may receive user input indicating an interest in acquiring a selected application. The input may be made in any suitable way, including clicking on a desktop icon, on a pop-up dialog window, or in a particular area of an applications launcher.

After having received user input indicating an interest in a selected application, at block 708, the client may request the selected application of interest to the user, and the server may receive the request at block 710. In some embodiments, rather than requesting to acquire the selected application from the server, the request may be made to a third party, such as an independent software vendor (ISV). At block 712, the server or the server of a third party, such as an ISV, may then provide the requested application to the client, and the client, at block 714, may obtain the selected application. The selected application may be obtained in any suitable way, including by downloading, streaming, or periodically obtaining portions of the application in the background over a network. In some embodiments, the selected application may only be provided to the client after having received additional information, such as payment information.

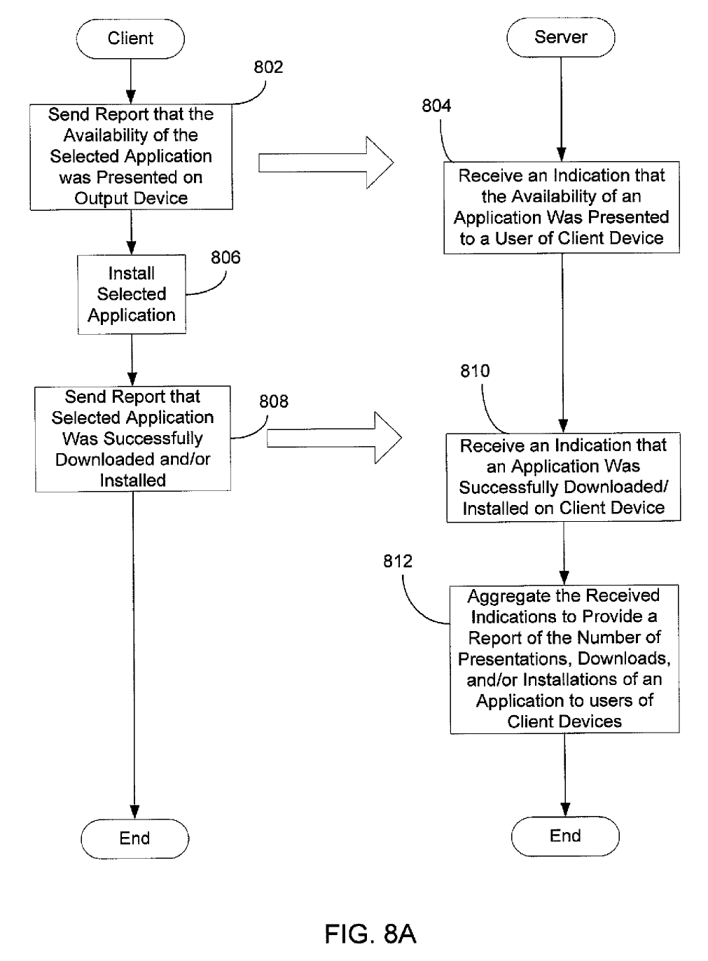

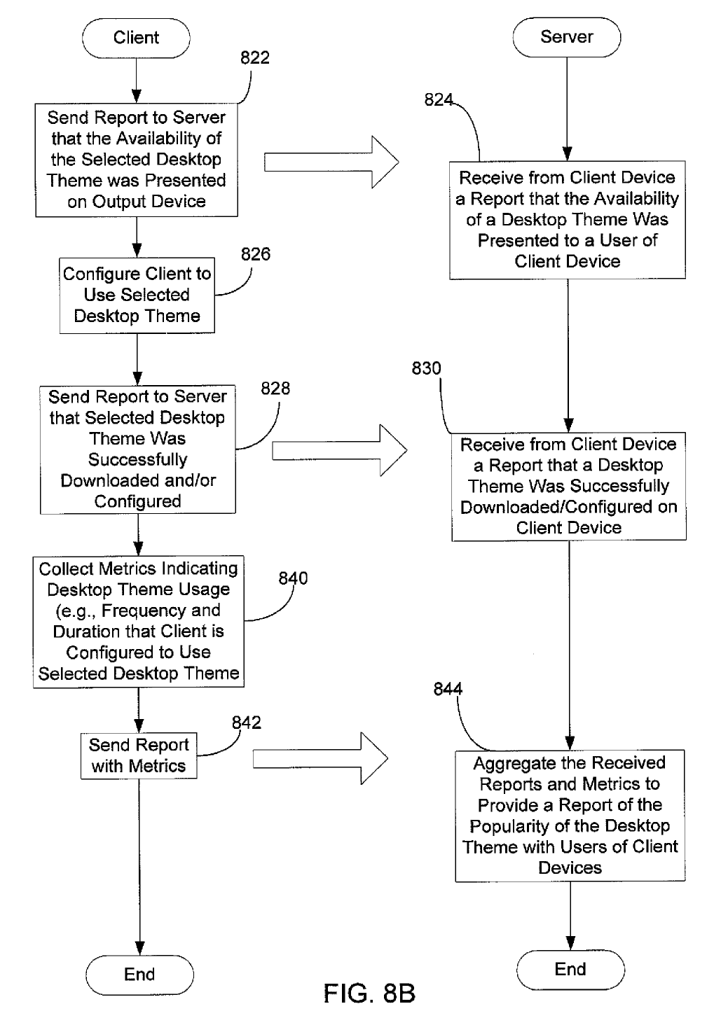

As the flowchart of FIG. 7A is done, the flow then turns to FIG. 8A, in which the client may, at block 802, report to the server that the availability of a selected application was presented on the output device. The server, at block 804, may receive and record an indication that the availability of an application was presented to a user on the output device. This may be particularly important when multiple suggested applications may be displayed to the user or when the user requests to acquire an application from a third party.

At block 806, the acquired application may be installed on the client. This may be done automatically by the client, or it may be done as the result of user input. At block 808, the client may then send a report to the server that a selected application was successfully obtained and/or installed. At block 810, the server may receive from the client the report indicating that an application was successfully installed and/or obtained by the client. The client may also include information in a report sent to the server about the usage of the suggested application, such as the frequency or duration that the suggested application or particular features of the suggested application are used.

At block 812, the server may aggregate the received indications to generate a report of the level of adoption of an application by users of client computing devices. The report may be based on, for example, indications of the usage of an application (or of application features) by users of the client devices. The report may additionally or alternatively be based on, for example, indications of a number of presentations, downloads, and/or installations of an application that were made on client computing devices. Block 812 may include aggregating indications across a plurality of computing devices. The report may be provided to a third party, such as a developer of the application, or an independent software vendor with a commercial interest in the application. For example, the report may be used for billing purposes, such as when the third party may be owed or given payment per sale or impression. The flowchart of FIG. 8A is done at this point.

Besides suggested applications or application plugins, suggested content may also include user interface settings, such as user interface themes. Accordingly, FIGS. 6B, 7B and 8B provide exemplary details for super-blocks 504, 508 and 510, respectively, for a particular embodiment in which the content is a user interface theme that may be obtained and installed onto the client. The user interface themes in this embodiment may include components that modify user interface settings, such as a desktop background, font, color scheme, mouse cursor, screen-saver, desktop icons, system sounds, login screen appearance, and boot screen appearance. The user interface theme may also include one or more active elements, which may appear on the user desktop, to provide services to the user. For example, the active element may be a “gadget,” such as may appear in the Windows® Sidebar included in various versions of the Windows® operating system developed by Microsoft Corporation. The gadget may relate thematically to the user interface theme. For example, in a sports-related theme, the active element may be a mileage tracker for the user to track miles run in a given time period. While, in a financial-related theme, the gadget may provide particular financial tools such as a mortgage calculator or it may include links, for example, to financial websites.

According to the embodiment in which the suggested content is a user interface theme, subsequent to the monitoring of user interactions performed at block 502, the flowchart turns to FIG. 6B, in which at block 622, the server may maintain a list of user interface themes. Each user interface theme may be associated with a user interest category. At block 624, the server may optionally maintain user interest categories, as well as indicia of user actions that indicate user association with each of the plurality of interest categories.

At block 626, the client may obtain user interest categories and indicia of user actions that indicate user association with each of the plurality of interest categories. This information may be stored locally on the client, or it may be obtained from the server, in which case the server may provide, at block 628, the user interest categories and the indicia of user actions that indicate user association with each of the plurality of interest categories. The information may be obtained from the server in any suitable way, such as via a download over a network. In embodiments in which the information is stored locally on the client, the information may periodically be updated or synchronized based on information maintained by the server.

At block 630, the server may provide a list of user interface themes, in which each user interface theme is associated with a user interest category, and at block 632, the client may obtain the list of user interface themes, such as by downloading the list from the server.

As the flowchart illustrated in FIG. 6B is now finished, the flow proceeds back to block 506 of FIG. 5, in which, in the embodiment of FIGS. 6B, 7B and 8B, the client may select a category based on a match between the monitored user interactions data and the indicia for user interactions that indicate membership in a particular user interest category. For example, a match for a sports category may be made if the monitored user interactions contain frequent visits by the user to sports broadcasting websites or the sports section of online newspapers. A match for a sports category may also be made if files or emails on the user's computer contain a sufficient number of sports-related keywords.

The process may then continue at FIG. 7B, in which at block 722, the client may select one or more user interface themes from the list of user interface themes, based on the selected user interest category. For example, a sports equipment manufacturer and a sports network broadcaster may each offer user interface themes in the sports user interest category, one or both may be selected by the client computing device.

At block 724, the client may present on an output device an indication that the selected user interface theme(s) is available for acquisition. This may be done in any suitable way, including as a desktop icon, a pop-up window, or a notification in a notification area of a desktop, such as a system tray notification in variants of the Windows® operating systems provided by Microsoft Corporation. A system tray may be a display area on the desktop containing icons representing available or actively running services or applications.

The client may then receive user input, at block 726 indicating user interest in acquiring a selected user interface theme. The user input may be received in any suitable way, including by clicking the mouse on any of the indications discussed above in connection with block 724.

At block 728, the user may request the selected user interface theme. The request may be made to the server, or to another computing device working in connection with the server. In embodiments in which the request is sent to the server, at block 730, the server may receive from the client the request for the selected theme in the user interface themes list. The computing device providing the theme, such as the server, may be a secure, trusted location. At block 732, the server (or the party from which the client requested the theme) may then provide the requested user interface theme to the client, which may obtain the selected user interface theme at block 734. The theme may be obtained in any suitable way, including via a download. In some embodiments, the client may first verify that the server (or other computing device providing the theme) is to be trusted before obtaining the theme and/or configuring the client device with the theme. The verification may be done in any suitable way, including using cryptographic identity verification techniques. The theme may be implemented in any suitable number of files or file formats, including an executable file format, that when downloaded and executed on the client, may apply the theme to the client desktop.

The process of FIG. 7B now being finished, the flow now proceeds to FIG. 8B. At block 822, the client may send a report to the server that the availability of the selected user interface theme was presented on an output device, and at block 824, the server may receive such a report.

At block 826, the client may configure itself to use the selected user interface theme. As discussed above, prior to configuring the client device to use the selected user interface theme, the client may first verify that the user interface theme provider may be trusted. Configuring the client to use the user interface theme may be done in any suitable way. In some embodiments, the client may automatically configure itself to use the selected user interface theme, while in other embodiments, the user may explicitly configure the client to use the theme, such as through a configuration tool that may be part of an operating system loaded on the client, in which the tool is used to modify the user interface settings of the client.

At block 828, the client computer may send a report to the server that the selected user interface theme was successfully downloaded and/or configured on the client, and at block 830, the client may receive such a report.

The client may then, at block 840, collect metrics indicating user interface theme usage. The metrics may include information such as the frequency and/or duration that the client is configured to use the selected user interface theme. For example, the user may frequently change the user interface theme configured on the computer, in which case the metrics may include, over a particular span of time, the frequency that the user interface theme was configured on the computer, a total amount of time that the user interface theme was configured on the client, and/or the average duration that the theme was configured for use on the client. The metrics may also include the frequency that particular components of the theme, such as desktop icons or active elements (e.g., gadgets), are clicked on by a user or otherwise interacted with by a user. At block 842, the client may then send a report to the server containing the metrics.

At block 844, the server may receive the metrics, and aggregate the received metrics and received reports to generate a report indicating the level of adaption of the user interface theme with users of client devices. The report generated at block 844 may be aggregated across a plurality of client devices. The report may be provided to a third party, such as developer of the theme or an entity thematically associated with the theme, such as, in the example of a sports theme, a sports equipment manufacturer. For example, the third party may be billed each time the user interface theme was presented to a user as being available. The third party may also be billed different amounts based on the metrics discussed above, such as the frequency and/or duration that a client device was configured with a particular user interface theme. The method of FIG. 8B may then be finished.

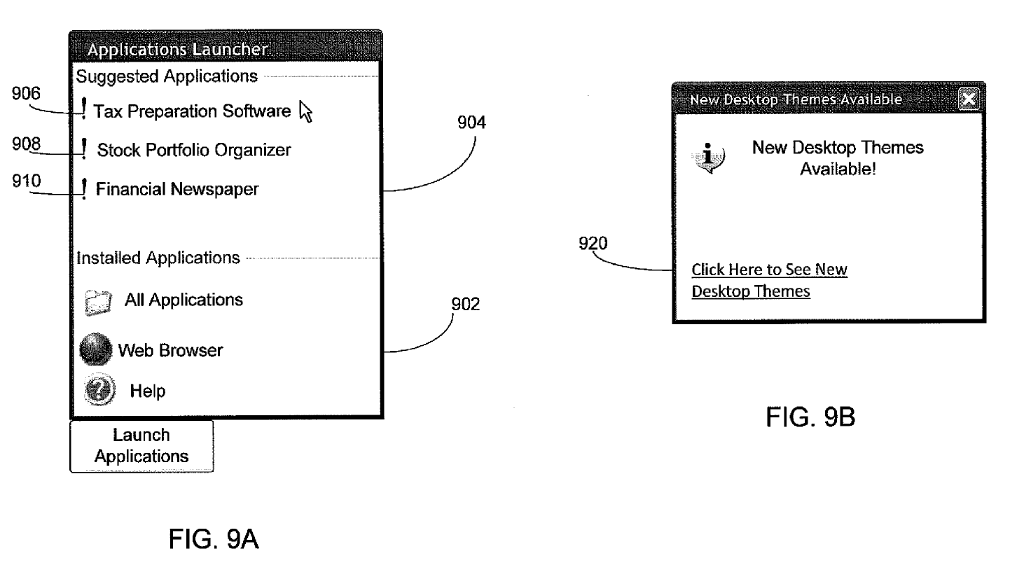

FIGS. 9A-13 illustrate various possible user interface elements that may be displayed to a user as part of a graphical user interface associated with embodiments of the invention relating to suggested applications and suggested user interface themes. FIG. 9A displays an application launcher, similar to what may be found in operating systems, such as variants of the Windows® operating system, which include an applications launcher, such as the “start menu,” which may be used for launching applications installed on a computing device loaded with the operating system, such as one of client computing devices 104a . . . 104c. The applications launcher in FIG. 9A includes an Installed Applications region 902, for launching installed applications, and a Suggested Applications region 904, for displaying an indication that suggested applications are available for acquisition. The example of FIG. 9A includes three suggested applications in a financial user interest category: tax preparation software 906, stock portfolio organizer 908, and financial newspaper 910. In the embodiment illustrated in FIG. 9A, the user may select one of these suggested applications for acquisition by clicking on the text or icon identifying the suggested application in the Suggested Applications region 904. The user may then acquire the application in any suitable way, which could include paying a third party for the application, and downloading the application. When the application is already loaded on the client device in a locked format, such as through digital rights management, acquiring the application may unlock the application for use.

FIG. 9B illustrates a dialog window 920 for notifying a user that new user interface themes are available for acquisition. In some embodiments, the dialog window 920 may be displayed in a particular area of the desktop, such as a notification area. For example, in variants of the Windows® operating system, the dialog window may be displayed above the system tray. Alternatively or additionally, the dialog window 920 may be displayed in response to user action, such as launching an operating systems tool such as a control panel for specifying desktop configuration settings.

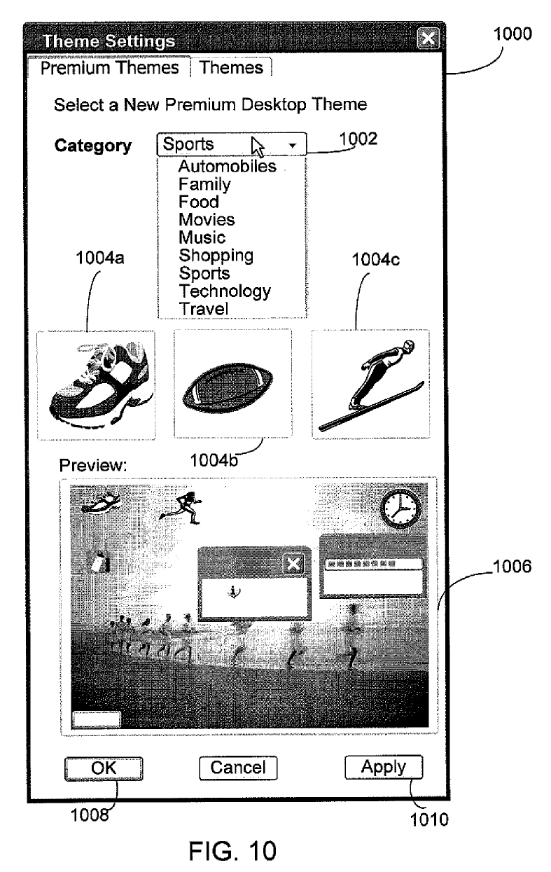

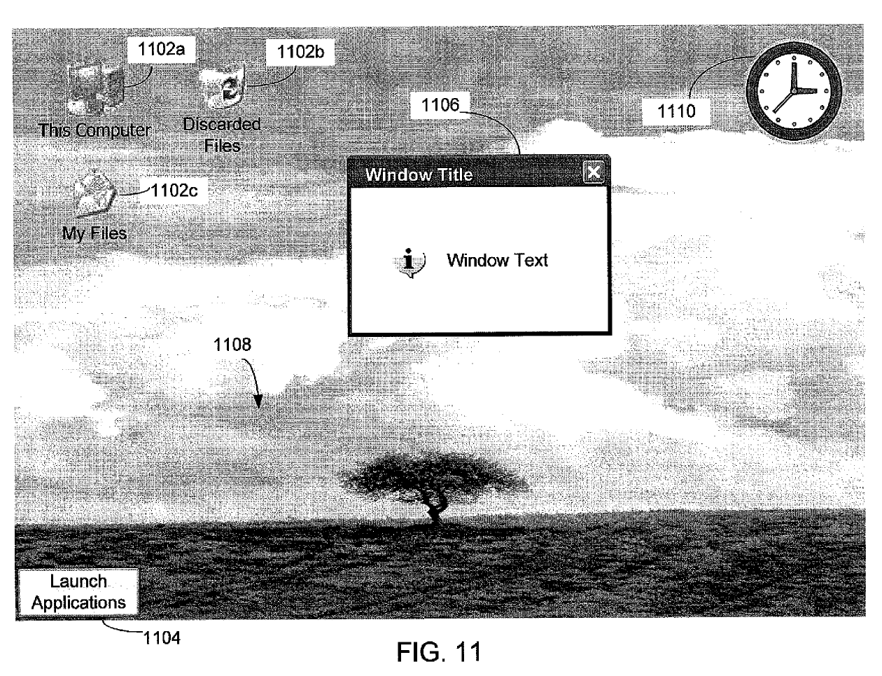

FIG. 10 is an illustrative user interface 1000 for selecting a new user interface theme for configuration on a client computer. The user interface 1000 may be a user interface control or active object that is launched in any suitable way, such as by clicking on a notification that additional themes are available, as is illustrated by dialog window 920 in FIG. 9B, or launched through an operating systems tool used to configure user interface settings. In the example of FIG. 10, the user interface themes described in FIGS. 6B, 7B and 8B are termed, “premium user interface themes,” as they may include additional features or content, such as an active element, login screen appearance or boot-up screen appearance.

The user interface 1000 includes a category selection pull-down menu 1002, which allows a user to select a user interest category from a list of categories. In the example of FIG. 10, the sports category has been selected. Accordingly, a choice of sports-related themes 1004a, 1004b and 1004c are displayed as being available for configuration. User interface 1000 also includes a preview area 1006, in which a preview of one of the themes, in this example sports-related theme 1004a, is displayed. When the user clicks the OK control 1008 or the apply control 1010, the user may configure the desktop of the client computing device to use the previewed theme. In some embodiments, a notification may be sent to a server identifying the user interface theme configured by a user on the client device. This notification may be used, for example, for charging the user for the use of the user interface theme, or alternatively, for receiving payment from a third party advertiser, such as a sports manufacturer featured in the theme in the example above, for each configuration by a user of the user interface theme.

FIG. 11 illustrates an exemplary desktop configuration showing a default theme. The desktop includes desktop icons 1102a, 1102b and 1102c, an applications launcher 1104, a dialog window 1106, a desktop background image 1108, and an active element 1110, here illustrated as a clock. The text associated with the desktop icons 1102a . . . 1102c, applications launcher 1104, and dialog window 1106 is displayed in a particular font corresponding to the default font. The color scheme for the window title bar and window background is also associated with the default theme.

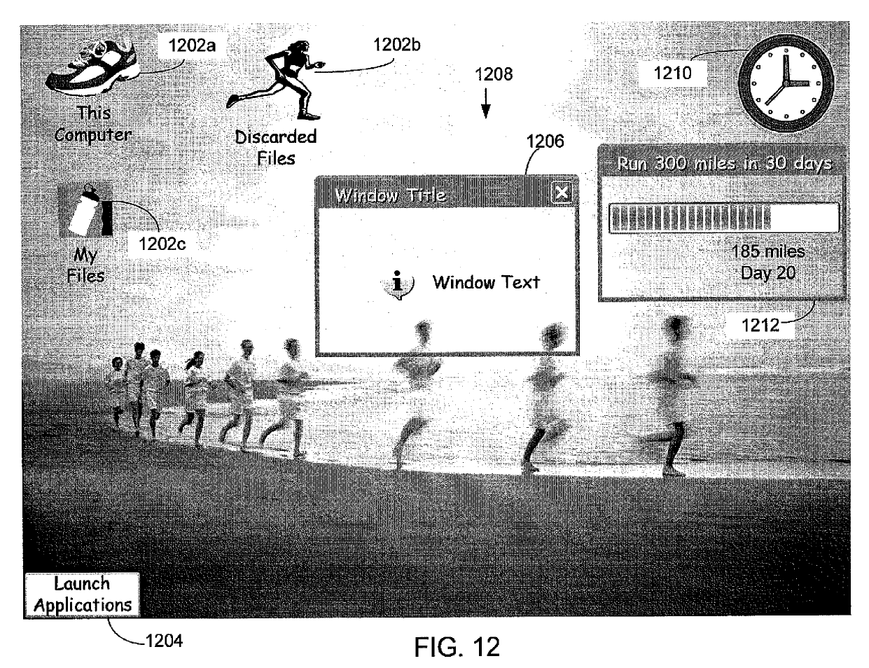

FIG. 12 illustrates an exemplary client desktop when the desktop has been configured with a sports-related theme, in this example, sports-related theme 1004a. The desktop configuration includes desktop icons 1202a, 1202b, and 1202c, which each has a different graphic than the desktop icon in the user interface theme illustrated in FIG. 11 that performs the same function. The client desktop of FIG. 12 also includes an application launcher 1204, dialog window 1206, a default active element 1210, and a sports-related active element 1212. In the example of FIG. 12, the sports-related active element provides a service to the user, by tracking and displaying the number of miles the user has run over the course of 30 days. As can be seen, the color scheme of the title bar and background for the dialog window 1206 and the sports-related active element 1212 differs from that in dialog window 1106, which is configured in accordance with the default theme. In addition, text associated with the desktop icons 1202, applications launcher 1204, dialog window 1206, and sports-related active element 1212 is displayed in a font corresponding to the sports-related theme, and differs from the default font, as displayed in FIG. 11. Similarly, desktop background image 1208, displaying runners, is appropriate for a sports-related theme, and differs from the default desktop image 1108, which displays a tree.

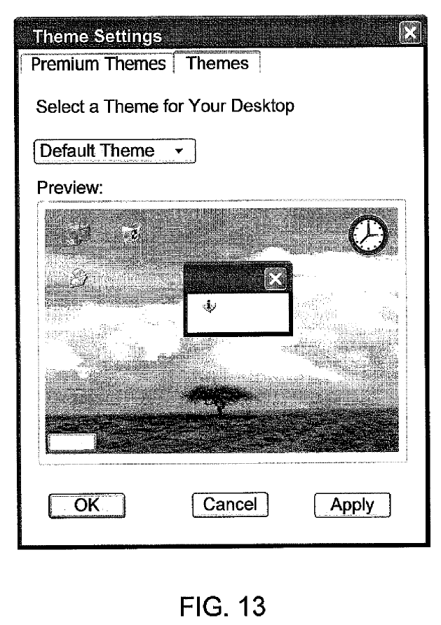

FIG. 13 illustrates another display of user interface 1000 illustrated in FIG. 10. In FIG. 13, rather than selecting a new premium theme for configuration of the client desktop, the user has selected to revert back to the default theme, illustrated in FIG. 11.

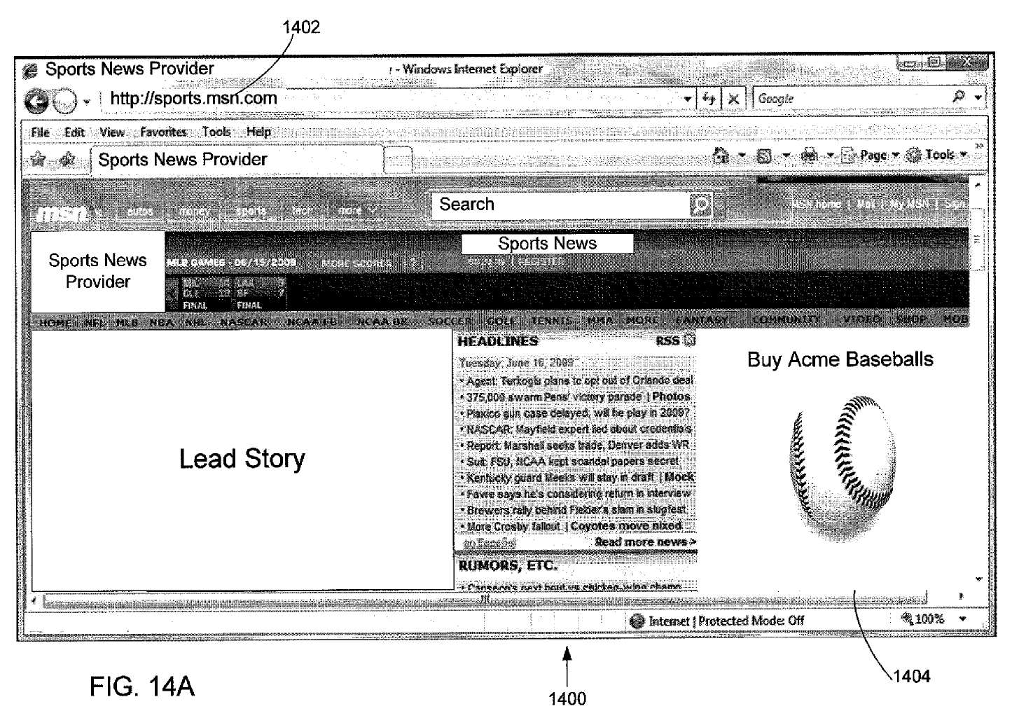

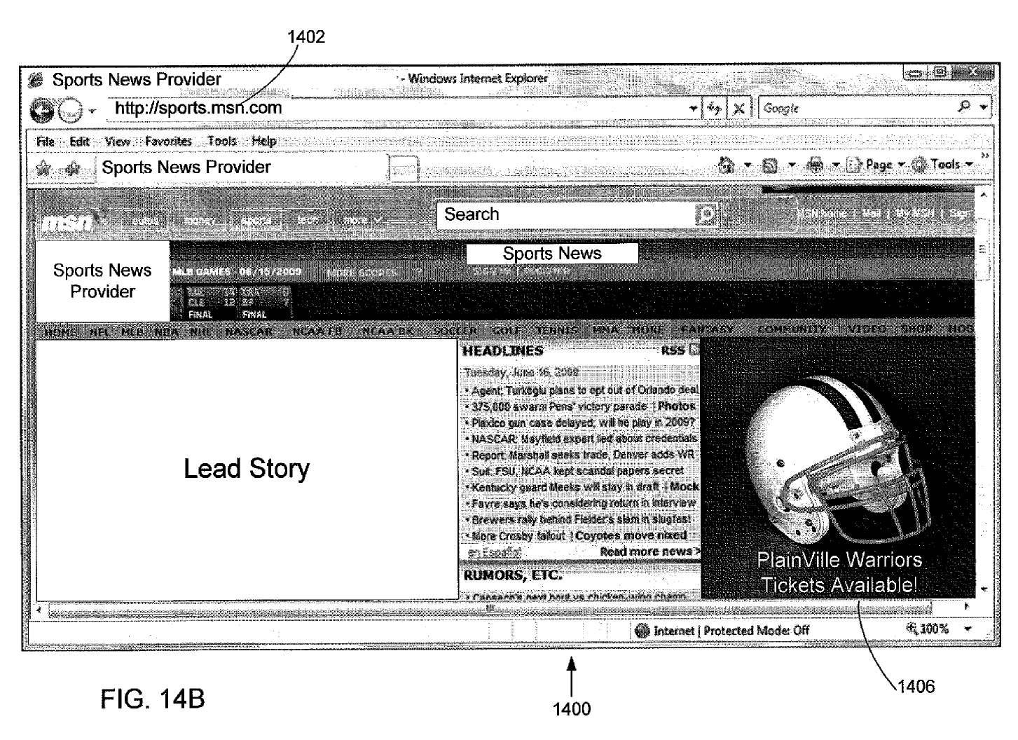

FIGS. 14A and 14B illustrate embodiments of the invention in which different types of targeted content may be delivered to the user based on different types of data being shared to a content provider. FIG. 14A illustrates a web browser application 1400 showing a webpage loaded in response to a request to a sports news provider at a website address 1402. As discussed in connection with FIG. 3A, the request may have included an identifier for the user, allowing the sports news provider to link the user to data related to user interactions already submitted by the user to the content provider. In the example of FIG. 14A, the user may have given permission to share a selected category with the content provider. The selected category may identify the user as a “sports enthusiast.” The loaded webpage includes targeted content 1404, which in this example, based on the selected category of “sports enthusiast,” may be an advertisement to purchase a particular brand of baseballs.

However, while the user may be a sports enthusiast, the user may have minimal interest in the sport of baseball, thus targeted content 1404 is not extremely relevant to the user. FIG. 14B illustrates an example of the same webpage at website address 1402 loaded in web browser 1400 in which the user may have shared the raw user interactions data with the content provider, thus resulting in more relevant content. In the example of FIG. 14B, the user may have consented to share raw user interactions data with the content provider. Thus, while the request to the website may take the same form as the request described above in connection with FIG. 14A, the user identifier may be linked to the raw user interactions data instead of or in addition to the selected category. In the example of FIG. 14B, the raw user interactions data may contain multiple occurrences of football-related content being accessed by the user, as well as indications based on website history that the user has searched for hotel and flight reservations for a visit to the city of PlainVille during a prominent football game. Based on the information in the user interactions data, the content provider may provide targeted content 1406 in the place of the targeted content 1404. Unlike the targeted content 1404, which was directed towards a general sports enthusiast, targeted content 1406 is directed to a football enthusiast who will be traveling to PlainVille during the period of a prominent football game. Thus, sharing raw user interactions data may result in a more relevant, more enjoyable user experience.

Having thus described several aspects of at least one embodiment of this invention, it is to be appreciated that various alterations, modifications, and improvements will readily occur to those skilled in the art.

For example, while the description of embodiments above described performing a one for one matching between a user interest category and a suggested content category, the matching could also be performed in other ways. For instance, the matching in some embodiments may be performed based on specific combinations of categories (e.g., sports and travel).

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. Computer storage media encoded with computer executable instructions, that, when executed by a computer, perform a method comprising:
obtaining user classification information, the user classification information defining a plurality of user interest categories and user interactions associated with each of the plurality of interest categories;
collecting user interactions data indicating user interactions with the computer; and
selecting a user interest category based on the classification information and the collected user interactions data.

2. The computer storage media of claim 1, wherein the method further comprises:
obtaining information identifying a plurality of computer applications executable on the computer, the plurality of computer applications each being associated with a user interest category of the plurality of user interest categories;
selecting a computer application of the plurality of computer application programs based on the selected user interest category; and
presenting on an output device of the computer an indication that the selected computer application is available for acquisition.

3. The computer storage media of claim 1, wherein:
the computer comprises an operating system that presents an application launcher; and
presenting on the output device comprises presenting the application in an area of the application launcher.

4. The computer storage media of claim 1, wherein selecting a user interest category is additionally based on an indication of user interest explicitly specified by the user.

5. The computer storage media of claim 1, wherein collecting user interactions data comprises analyzing text in data documents stored on the computer.

6. The computer storage media of claim 1, wherein collecting user interactions data comprises detecting a networking command indicating a connection to a web site and the collected user interactions data comprises an identification of the web site and/or a portion of the web site.

7. The computer storage media of claim 6, wherein detecting a networking command comprises receiving from a browser executing on the computer a request to connect to a web site.

8. The computer storage media of claim 7, wherein the collected user interactions data further comprises data representing text transmitted to the web site.

9. A method of operating a computer, comprising:
operating a processor to:
obtain user classification information, the user classification information defining a plurality of user interest categories and indicia of user actions that indicate user association with each of the plurality of interest categories;
collect user interactions data indicating user interactions with the computer;
select a user interest category based on the classification information and the collected user interactions data;
select an application program based on the selected user interest category; and
present through an output device of the computer an indication that the selected application program is available for acquisition.

10. The method of claim 9, further comprising:
in response to presenting the indication that the application program is available, receiving user input selecting an option to acquire the application program; and
in response to the user input, obtaining the application program over a network.

11. The method of claim 9, wherein presenting through an output device comprises presenting the indication in an area of a graphical user interface designated for presenting to a user application programs available for acquisition.

12. The method of claim 9, wherein:
the indicia of user actions of the classification information comprise portions of text; and
collecting user interactions data comprises accessing an index of a hard drive on the computer to determine whether portions of text comprising the indicia are stored on the hard drive.

13. The method of claim 9, wherein the method further comprises, sending a report to a server that that the indication that the selected application program is available for acquisition was presented through the output device.

14. The method of claim 9, wherein:
the method further comprises obtaining information identifying a plurality of application programs, each application program having a user interest category assigned thereto;
selecting an application program comprises selecting an application program assigned to the selected user interest category; and
the method further comprises sending an indication to a server that the selected application was presented to the user.

15. The method of claim 9, wherein:
the indicia of user actions of the classification information comprise information identifying software modules and usage information criteria associated with the software modules; and
collecting user interactions data comprises tracking usage information of software modules installed on the computer.

16. The method of claim 15, wherein the usage information comprises the frequency and/or duration that software modules are used by a user.

17. The method of claim 16, wherein the usage information further comprises the frequency that particular features of software modules are used by a user.

18. A method of operating a computer system, the method comprising:
with at least one computing device adapted for connection to a plurality of client devices over a network:
maintaining application information on a plurality of application programs, the application information associating a user interest category with each of the plurality of applications, the user interest category comprising a user interest category of a plurality of user interest categories;
maintaining user categorization information identifying indicia of user membership in each of the plurality of user interest categories;
in response to a request from the plurality of client devices, providing the application information and the user categorization information over the network to the client devices;
receiving from each of at least a portion of the plurality of client devices an indication that information describing an application of the plurality of applications was presented to a user; and
aggregating the received indications to provide a report of the level of adoption of an application of the plurality of applications by users of the plurality of client devices.

19. The method of claim 18, wherein the method further comprises receiving from a client device of the plurality of client devices an indication that an application of the plurality of applications was successfully obtained and installed on the client device.

20. The method of claim 19, wherein the method further comprises receiving from a client device of the plurality of client devices an indication of the frequency and/or duration that an application of the plurality of applications was used by a user of the client device.
